(19) United States
(12) Patent Application Publication
(10) Pub. No.: US 2024/0322357 A1
(43) Pub. Date: Sep. 26, 2024

(54) Battery Pack

(71) Applicant: SK On Co., Ltd., Seoul (KR)

(72) Inventor: Se Hyeon KIM, Daejeon (KR)

(21) Appl. No.: 18/607,689

(22) Filed: Mar. 18, 2024

(30) Foreign Application Priority Data
Mar. 22, 2023 (KR) 10-2023-0037439

(51) Int. Cl. H01M 50/367; H01M 50/186; H01M 50/204; H01M 50/289; H01M 50/342

(52) U.S. Cl. CPC H01M 50/367; H01M 50/3425; H01M 50/186; H01M 50/204; H01M 50/289

(57) ABSTRACT

A battery pack is provided, the battery pack including: a plurality of battery modules including a cell assembly in which a plurality of battery cells are assembled and a protective cover on which the cell assembly is seated and in which a venting hole is formed; a pack case protecting the plurality of battery modules from the outside; a protective sheet disposed to face the venting hole, and configured to have a hole formed in at least a portion of the protective sheet by gas discharged from the cell assembly; and a venting guide member having an internal space, and contacting the protective sheet, wherein the venting guide member includes an exhaust portion formed on one surface in contact with the protective sheet, and the gas discharged from the cell assembly moves to the internal space of the venting guide member, passing through the protective sheet and the exhaust portion.

### CROSS-REFERENCE TO RELATED APPLICATION(S)

This patent document claims the priority and benefits of Korean Patent Application No. 10-2023-0037439 filed on Mar. 22, 2023, the disclosure of which is incorporated herein by reference in its entirety.

### TECHNICAL FIELD

The present disclosure relates to a battery pack.

### BACKGROUND

Unlike primary batteries, a secondary battery is convenient in that secondary batteries may be charged and discharged of electricity, and are receiving a lot of attention as power sources for various mobile devices and electric vehicles. For example, a battery module can be formed by connecting a plurality of secondary batteries using a non-aqueous electrolyte with high energy density, and this battery module may be used as a power source for an electric vehicle.

When the battery module receives a severe impact from the outside, or undergoes repeated harsh charging and discharging, battery cells inside the battery module may ignite, resulting in a thermal runaway phenomenon in which high-temperature gas or flames are generated.

### SUMMARY

An aspect of at least a portion of embodiments of the present disclosure is to provide a battery pack that can reduce or prevent gas generated by a battery module from being transferred to an adjacent battery module.

An aspect of at least a portion of embodiments of the present disclosure is to provide a battery pack reducing or preventing thermal runaway.

According to an aspect of achieving at least a portion of embodiments of the present disclosure, a battery pack is provided, the battery pack including: a plurality of battery modules including a cell assembly in which a plurality of battery cells are assembled and a protective cover on which the cell assembly is seated and in which a venting hole is formed; a pack case protecting the plurality of battery modules from the outside; a protective sheet disposed to face the venting hole; and a venting guide member having an internal space, and contacting the protective sheet, wherein the venting guide member includes an exhaust portion formed on one surface in contact with the protective sheet, and the gas discharged from the cell assembly moves to the internal space of the venting guide member, passing through the protective sheet and the exhaust portion.

In an embodiment, the protective sheet may be disposed to cover the exhaust portion.

In an embodiment, the protective sheet may be disposed to cover the venting hole.

In an embodiment, the protective sheet may include a vulnerable portion formed on one surface thereof facing the venting hole, and a hole is formed in the vulnerable portion when the protective sheet is pressed by the gas discharged from the cell assembly.

In an embodiment, the plurality of venting holes may be formed in the protective cover, and at least a portion of the plurality of venting holes may be formed in at least a portion of an edge of the protective cover.

In an embodiment, the venting hole may have a shape extending in a first direction, and the exhaust portion may have a shape extending in the first direction.

In an embodiment, the venting guide member may include a discharge hole formed in both of the ends of the venting guide member, and gas flowing into the internal space of the venting guide member may be discharged externally of the venting guide member through the discharge hole.

In an embodiment, the exhaust portion may be disposed to correspond to the venting hole.

In an embodiment, the pack case may include a side frame surrounding a side surface of the battery module, and the venting guide member may be coupled to the side frame.

In an embodiment, the protective sheet may include a plurality of sheets, and each of the sheets may be disposed to cover each of the plurality of battery modules.

In an embodiment, the battery pack may further include a cooling plate member disposed to face at least a portion of the plurality of battery modules and cooling at least a portion of the plurality of battery cells.

In an embodiment, each of the plurality of battery cells may include a sealing portion, and at least a portion of the sealing portion may be disposed to face the protective sheet.

In an embodiment, the venting guide member may be disposed below the plurality of battery modules.

In an embodiment, the pack case may include a cross frame partitioning a space in which the plurality of battery modules are accommodated.

### BRIEF DESCRIPTION OF DRAWINGS

Certain aspects, features, and advantages of the present disclosure are illustrated by the following detailed description with reference to the accompanying drawings.

FIG. 1 is an exploded perspective view of a battery pack according to an embodiment of the present disclosure.

FIG. 2 is an exploded perspective view of the battery module illustrated in FIG. 1.

FIG. 3 is a perspective view of the battery cell illustrated in FIG. 2.

FIG. 4 is a perspective view illustrating a portion of the battery module illustrated in FIG. 1, a venting guide member, and a protection sheet.

FIG. 5 is a cross-sectional view taken along the line I-I′ of the battery pack in FIG. 1.

FIG. 6 is a cross-sectional view when a portion of the battery cells illustrated in FIG. 5 ignite.

FIG. 7 is an enlarged view of portion A of FIG. 6.

### DETAILED DESCRIPTION

Hereinafter, the present disclosure will be described in detail with reference to the attached drawings. However, this is merely illustrative and the present disclosure is not limited to the specific embodiments described by way of example embodiments.

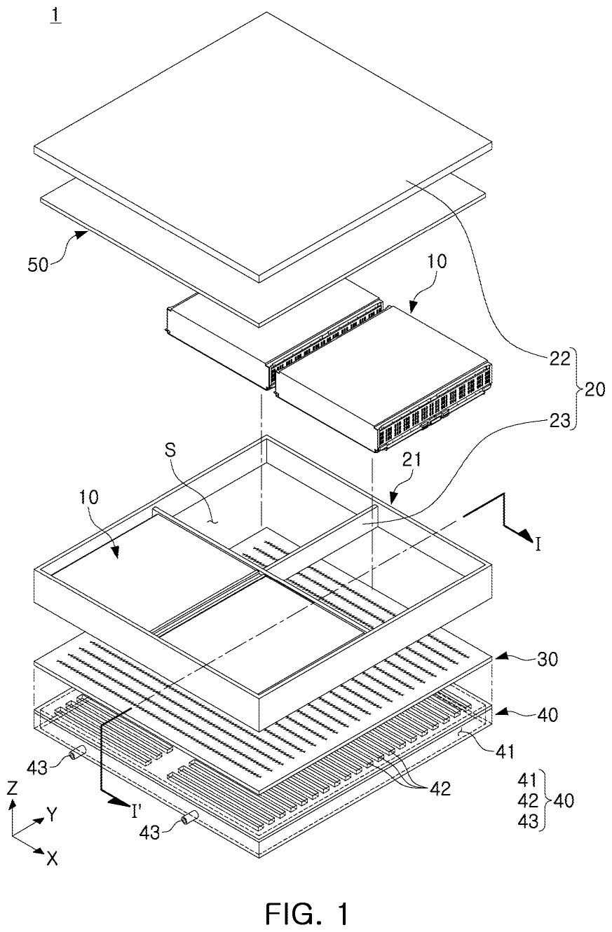

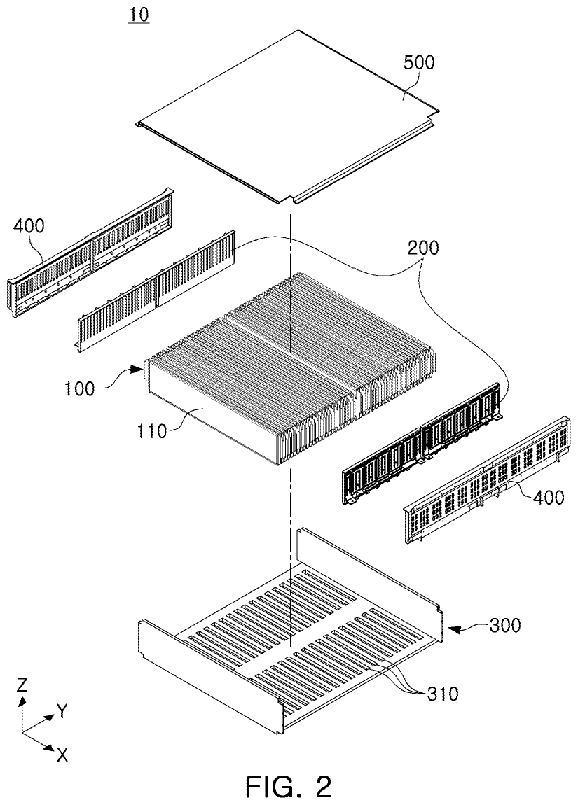

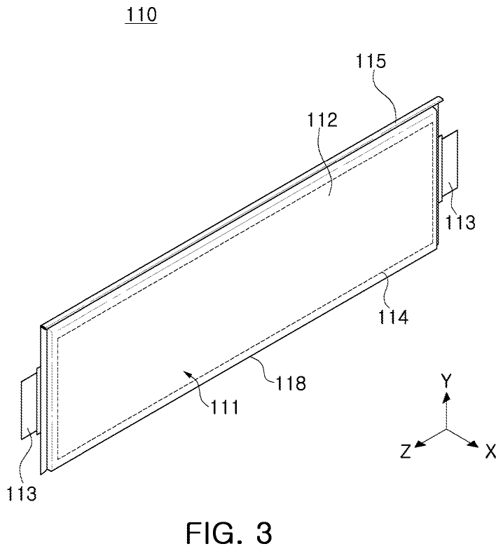

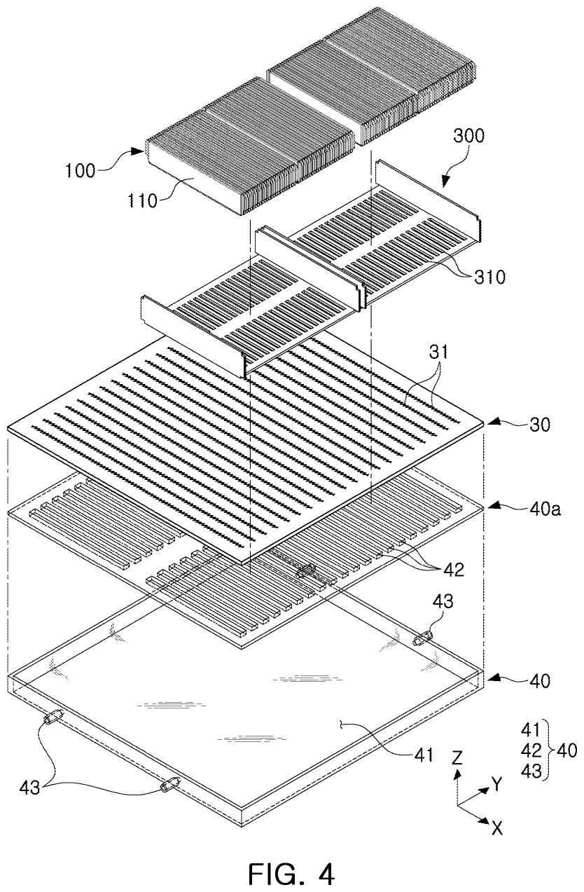

FIG. 1 is an exploded perspective view of a battery pack according to an embodiment of the present disclosure. FIG. 2 is an exploded perspective view of the battery module illustrated in FIG. 1. FIG. 3 is a perspective view of the battery cell illustrated in FIG. 2. FIG. 4 is a perspective view illustrating the battery module, the venting guide member, and the protective sheet illustrated in FIG. 1.

Referring to FIG. 1, the battery pack 1 may include a plurality of battery modules 10, a pack case 20, a protective sheet 30, and a venting guide member 40.

The pack case 20 may protect the battery modules 10 from the outside.

The pack case 20 may include a side frame 21 surrounding side surfaces of the battery modules 10, a cover frame 22 coupled to the side frame 21 and covering the battery module 10, and a cross frame 23 partitioning an accommodation space S in which the plurality of battery modules 10 are accommodated.

The side frame 21 may form a side surface of the battery pack 1. The side frame 21 may be coupled to the venting guide member 40 along the edge of the venting guide member, 40 and may form an accommodation space S in which the battery module 10 is accommodated.

The cover frame 22 may form an upper surface of the battery pack 1. The cover frame 22 may be disposed above the side frame 21 to entirely cover the battery modules 10. In the following description, ‘above’ or ‘upper direction’ may mean a positive direction of a Z-axis, and ‘below’ or ‘lower direction’ may mean a negative direction of the Z-axis.

A plurality of accommodation spaces S may be formed in the battery pack 1. The plurality of accommodation spaces S may be formed by a cross frame 23 crossing a portion of the accommodation spaces S. As an example, the cross frame 23 may be disposed to cross the accommodation space S in a first direction (X-direction) and a second direction (Y-direction), and the accommodation space S inside the side frame 21 may be partitioned by the cross member 23 and formed in plural. The number and disposition method of the cross frames 23 are not limited to the form illustrated in FIG. 1, and may be variously changed.

FIG. 1 illustrates a battery pack 1 having four accommodation spaces S and one battery module 10 disposed in each accommodation space S. However, this is merely an example, and the battery pack 1 may have more accommodation spaces S, and one battery module 10 or one or more battery modules 10 may be disposed in each accommodation space S.

The venting guide member 40 may form a lower surface of the battery pack 1. For example, the battery module 10 may be seated and disposed on the venting guide member 40.

A space may be formed inside the venting guide member 40. As an example, the venting guide member 40 may be formed in a form of a box having an internal space 41. As will be described later, when a portion of the battery cells 110 ignite and gas is discharged, the gas may move through the internal space 41 formed inside the venting guide member 40.

The venting guide member 40 may include an exhaust portion 42 so that the internal space 41 communicates externally. As an example, the exhaust portion 42 may be composed of a through hole formed on one surface of the venting guide member 40. The exhaust portion 42 may be formed on an upper surface of the venting guide member 40 to face the battery module 10.

The venting guide member 40 may include a discharge hole 43 disposed on an outer surface of the venting guide member 40 to discharge gas or flames moving through the internal space 41 externally of the battery pack 1. The discharge hole 43 may be formed in an end of the venting guide member 40. For example, the discharge hole 43 may be disposed in both of the ends of the venting guide member 40 in a second direction (Y-direction), but the present disclosure is not limited thereto.

The protective sheet 30 may be disposed between the venting guide member 40 and the battery module 10. The protective sheet 30 may be in contact with the venting guide member 40, and may be disposed to cover an exhaust portion 42 formed in the venting guide member 40.

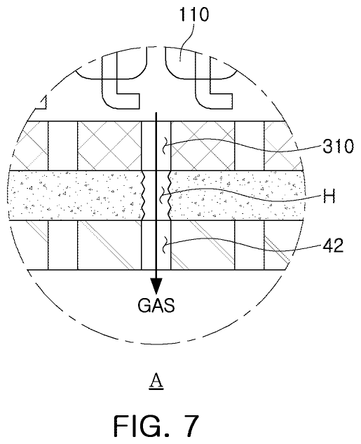

The protective sheet 30 may be formed of a fire-resistant or heat-resistant material. As an example, the protective sheet 30 may be formed of an inorganic compound, or the like, but the present disclosure is not limited thereto. The protective sheet 30 may be disposed between the venting guide member 40 and the battery module 10, and may be in a closed state. However, when the battery cell (110 in FIG. 2) ignites and high-temperature, high-pressure gas is discharged, a portion of the protective sheet 30 may be damaged and a hole may be formed, and gas and flames may pass through the formed hole, and gas, flames, or foreign substances (combustible material) may move through the formed hole. This will be described later through FIGS. 6 and 7.

Referring to FIG. 1, the protective sheet 30 may correspond to the venting guide member 40, and one protective sheet 30 may be provided. In this case, a size of the protective sheet 30 may be formed similarly to the size of the venting guide member 40. However, the protective sheet 30 is not limited to the size illustrated in FIG. 1, and the protective sheet 30 may be formed to fit the size of the battery module 10. For example, the protective sheet 30 may include a plurality of sheets, and each of the sheets may be disposed to face one surface of each of the battery module 10. Moreover, each of the sheets may be disposed to cover each of the plurality of battery modules. Hereinafter, for convenience of explanation, description will be made based on the battery pack 1 on which one protective sheet 30 is disposed.

The battery pack 1 may further include a cooling plate member 50 for cooling a plurality of battery cells 110.

The cooling plate member 50 may be disposed to face at least a portion of the plurality of battery modules 10 and may be cooling at least a portion of the plurality of battery cells 110. For example, the cooling plate member 50 may be disposed to cover the plurality of battery modules 10, and may be disposed on an opposite side of the position in which the protective sheet 30 is disposed. Referring to FIG. 1, the cooling plate member 50 may be disposed above the battery module 10, and the protective sheet 30 may be disposed below the battery module 10. However, it is not limited to the dispositional method illustrated in FIG. 1, and the protective sheet 30 may be disposed above the battery module 10, and the cooling plate member 50 may be disposed below the battery module 10.

The cooling plate member 50 may be comprised of a cooling passage through which a cooling medium flows and a metal plate member surrounding the cooling passage. The metal plate member may be formed of aluminum, copper, magnesium, and the like, having excellent thermal conductivity, but the present disclosure is not limited thereto. The cooling medium flowing through the cooling passage may comprise gas such as air as well as a liquid such as a coolant.

In the present specification, the description is made based on the battery pack 1 in which the venting guide member 40 is disposed therebelow, but the present disclosure is not limited thereto. For example, the cover frame 22 may form a lower surface of the battery pack 1, and the venting guide member 40 may form an upper surface of the battery pack 1. When the venting guide member 40 forms the upper surface, a venting hole 310, to be described later with reference to FIG. 2, may be formed on the upper surface of the battery module 10. However, in the present specification, for convenience of explanation, the battery pack 1 in which the venting guide member 40 is disposed therebelow is taken as an example.

Next, the battery module 10 accommodated in the battery pack 1 will be described in more detail with reference to FIG. 2.

As illustrated in FIG. 2, the battery module 10 may include a cell assembly 100 including a plurality of battery cells 110, a busbar assembly 200 electrically connected to the cell assembly 100, a protective cover 300 on which the cell assembly 100 is seated, an end cover 400 supporting a side surface of the cell assembly 100, and an upper cover 500 protecting an upper portion of the cell assembly 100.

The cell assembly 100 may include a plurality of battery cells 110 assembled in a second direction (Y-direction). The plurality of battery cells 110 may be stacked in the second direction (Y-direction) to form at least a portion of the cell assembly 100. The battery cells 110 will be described in detail later with reference to FIG. 3.

The cell assembly 100 may further include a protective member (not shown) disposed between the battery cells 110. For example, the protective member may be disposed between the battery cells 110, and may be an insulating member blocking heat propagation between the battery cells 110, or may be a compressible member facing the battery cell 110 to provide a surface pressure to the battery cells 110.

The busbar assembly 200 may be disposed opposite to one side of the cell assembly 100. For example, referring to FIG. 2, the busbar assembly 200 may be disposed to oppose the cell assembly 100 in a first direction (X-direction).

The busbar assembly 200 may be provided as a pair, and one of the busbar assemblies 200 may be disposed on each side of both sides of the cell assembly 100 in the first direction (X-direction).

The busbar assembly 200 may include a conductive busbar and a terminal portion. The conductive busbar may electrically connect the plurality of battery cells 110. The terminal portion may be electrically connected to the conductive busbar, and may be exposed externally of the battery module 10. The battery cells 110 of the cell assembly 100 may be electrically connected externally of the battery module 10 through the terminal portions.

The battery module 10 may further include an end cover 400 facing the busbar assembly 200. The end cover 400 may be formed of a rigid material (e.g., a metal such as aluminum or a resin compound), and may protect the cell assembly 100 and the busbar assembly 200 from external impact.

The cell assembly 100 is seated on the protective cover 300, which forms a lower surface and a side surface of the battery module 10. In FIG. 2, the protective cover 300 integrally covering the lower and the side surface of the battery module 10 is illustrated, but the present disclosure is not limited thereto. For example, the protective cover 300 may have a structure in which a cover forming the lower surface and a cover forming the side surface are separated. In this case, the venting hole 310 may be formed in the cover forming the lower surface.

The protective cover 300 may include the venting hole 310 which communicates the inside and outside of the battery module 10. The venting hole 310 can discharge gas generated inside the battery module 10 externally of the battery module 10. For example, when a portion of the cell assembly 100 ignites and gas is generated, the generated gas may be discharged below the battery module 10 through the venting hole 310.

A portion of the venting holes 310 may be formed in the protective cover 300 to correspond to a position in which the cell assembly 100 is disposed. Accordingly, when gas is generated by the cell assembly 100, the gas can be immediately discharged through the venting hole 310 formed at a position corresponding to the cell assembly 100.

Referring to FIG. 2, the venting holes 310 may be formed to have a length in a first direction (X-direction), and may be formed in plural. However, the spirit of the present disclosure is not limited to the shape and number of venting holes 310, and the shape and number of venting holes 310 can be freely changed.

The protective cover 300 may be coupled to the end cover 400. For coupling, coupling methods commonly used by those skilled in the art may be used, such as welding and coupling through a fastening member.

The upper cover 500 may be disposed above the cell assembly 100 to form an upper surface of the battery module 10.

Like the end cover 400, the protective cover 300 and the upper cover 500 may be formed of a rigid material (e.g., a metal such as aluminum or a resin compound), and may protect the cell assembly 100 from external impacts.

The battery module 10 may further include a heat blocking member (not shown) disposed between the protective cover 300 and the cell assembly 100. The heat blocking member may be formed of a material with heat resistance or insulation properties, such as mica, ceramic wool, or airgel, and may block high-temperature heat from spreading in a downward direction of the cell assembly 100.

Next, a battery cell accommodated in a battery module will be described in more detail with reference to FIG. 3.

Referring to FIG. 3, the battery cell 110 may include an electrode accommodation portion 112 configured to accommodate an electrode assembly 114 within a pouch 111 and a plurality of lead tabs 113 electrically connected to the electrode assembly 114 and exposed externally of the pouch 111.

The electrode assembly 114 may include a plurality of electrode plates. Here, the electrode plate may include a positive electrode plate and a negative electrode plate. The electrode assembly 114 may be composed of the positive electrode plate and the negative electrode plate stacked with a separator interposed therebetween. Each of the plurality of positive electrode plates and the plurality of negative electrode plates may include an uncoated portion on which no active material is applied, and the uncoated portions may be connected so that the uncoated portions having the same polarity contacts each other. The uncoated portions of the same polarity are electrically connected to each other and may be electrically connected to other external components to the battery cell 110 through the lead tab 113. In the case of the battery cell 110 illustrated in FIG. 3, it is illustrated that the two lead tabs 113 are withdrawn in opposite directions from the electrode accommodation portion 112, but the two lead tabs 113 may be configured to be withdrawn in the same direction from one side of the electrode accommodation portion 112.

The pouch 111 surrounds the electrode assembly 114, forms an appearance of the electrode accommodation portion 112, and provides an internal space in which the electrode assembly 114 and an electrolyte (not shown) are accommodated. The pouch 111 may be formed by folding a single sheet of exterior material. For example, the pouch 111 may be configured by folding a single sheet of exterior material in half and accommodating the electrode assembly 114 therebetween. The exterior material may be formed of a material that can protect the electrode assembly 114 from an external environment, and may include, for example, an aluminum film.

The exterior material may be bonded to an edge of the pouch 111 to form a sealing portion 115. A heat fusion method may be used to bond the exterior material to form the sealing portion 115, but the present disclosure is not limited thereto. In order to increase bonding reliability of the sealing portion 115 and minimize an area of the sealing portion 115, at least a portion of the sealing portion 115 may be formed in a shape that is folded one or more times.

The sealing portion 115 may not be formed on a surface in which the pouch 111 is folded along one edge of the electrode assembly 114. A portion in which the pouch 111 is folded along one edge of the electrode assembly 114 is defined as a folding portion 118 to distinguish the portion from the sealing portion 115. The pouch 111-type battery cell 110 may have the sealing portion 115 formed on three surfaces of the four edges of the pouch 111, and a form of a three-sided sealing pouch 111 in which the folding portion 118 is formed on the other side thereof.

The battery cell 110 of the embodiments is not limited to the form of the three-sided sealing pouch 111 described above. For example, a pouch may be formed by overlapping two sheets of different exterior materials, and a sealing portion may be formed on all four sides of an edge of the pouch. For example, the sealing portion may be composed of a two-sided sealing portion on which lead tabs are disposed, and other two-sided sealing portions on which the lead tabs are not disposed.

In addition, the battery cell 110 included in the battery module 10 of the embodiments is not limited to the pouch-type battery cell 110 described above, and may also be composed of a cylindrical battery cell or a prismatic battery cell.

FIG. 4 is a perspective view illustrating a portion of the battery modules 100 and 300, the protective sheet 30, and the venting guide member 40 illustrated in FIG. 1. In FIG. 4, in order to clearly illustrate the positions of the venting hole 310 and the exhaust portion 42, components other than the cell assembly 100 and the protective cover 300 of the battery module (10 in FIG. 1) are omitted. In addition, in FIG. 4, an upper surface 40a of the venting guide member 40 is illustrated to be disassembled to clearly illustrate the internal space 41 of the venting guide member 40.

Referring to FIG. 4, the protective sheet 30 may face the protective cover 300 in which the venting hole 310 is formed. The protective sheet 30 may be disposed to contact the protective cover 300, but the present disclosure is not limited thereto. When the protective sheet 30 and the protective cover 300 come into contact, the protective sheet 30 may be disposed to cover the venting hole 310. The protective sheet 30 may be formed of a fire-resistant and heat-resistant material. The protective sheet 30 may be disposed between the protective cover 300 and the venting guide member 40 to serve to block the movement of heat and gas.

At least a portion of the venting holes 310 may be formed on at least a portion of the edge of the protective cover 300. For example, a portion of the venting hole 310 may be formed on both sides of the protective cover 300 in a second direction (Y-direction). That is, heat and gas generated by a side surface of the battery module 10 may be discharged through the venting hole 310 formed on at least a portion of the edge.

The exhaust portion 42 may be formed on the upper surface 40a of the venting guide member, and may be disposed to correspond to the venting hole 310 of the protective cover 300. For example, a shape of the exhaust portion 42 and a position in which the exhaust portion 42 is formed may correspond to a shape of the venting hole 310 and a position in which the venting hole 310 is formed.

Referring to FIG. 4, the venting hole 310 may be formed to have a shape extending in a first direction (X-direction), and the exhaust portion 42 may also be formed to have a shape extending in the first direction (X-direction) like the venting hole 310. In addition, the venting hole 310 may be disposed to be spaced apart in a second direction (Y-direction), perpendicular to the first direction (X-direction), and the exhaust portion 42 may also be disposed to be spaced apart in the second direction (Y-direction). As an example, the exhaust portion 42 may be formed in the same manner as the shape of the venting hole 310 and the position in which the venting hole 310 is disposed. Accordingly, the gas discharged through the venting hole 310 may easily pass through the exhaust portion 42. The shape of the venting hole 310 and the position in which the venting hole 310 is formed and the shape of the exhaust portion 42 and the position in which the exhaust portion 42 is formed, illustrated in FIG. 4 are merely examples, and the shapes of the venting hole 310 and the positions in which the venting hole 310 and the exhaust portion 42 are formed may be variously changed.

The vulnerable portion 31 may be formed on one surface of the protective sheet 30. Specifically, the vulnerable portion 31 may be formed on one surface of the protective sheet 30 in a region facing the venting hole 310 formed in the protective cover 300. As an example, the vulnerable portion 31 may be a scratch or groove formed on a surface of the protective sheet 30. When the protective sheet 30 is pressed, the vulnerable portion 31 can easily form a hole (H in FIG. 7) in the protective sheet 30.

The vulnerable portion 31 may be formed to correspond to the exhaust portion 42. For example, the vulnerable portion 31 may be formed to correspond to a position in which the exhaust portion 42 is formed. Accordingly, the gas may move to the internal space 41 of the venting guide member 40, sequentially passing through the hole (H in FIG. 7) and the exhaust portion 42.

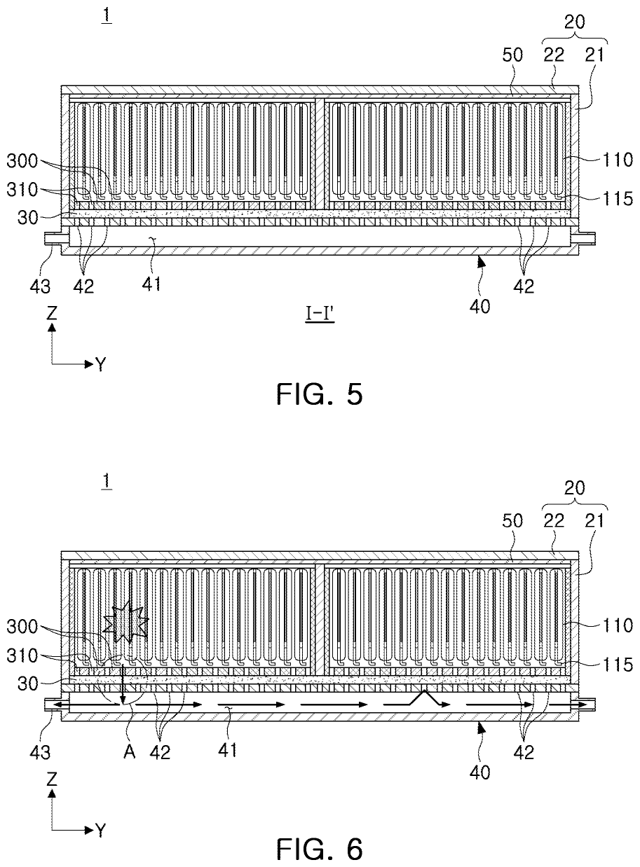

FIG. 5 is a cross-sectional view taken along the line I-I′ of the battery pack 1 in FIG. 1.

Referring to FIG. 5, at least a portion of a sealing portion 115 may be disposed to face the protective sheet 30 (e.g., below the battery pack). When the sealing portion 115 is disposed therebelow, a portion of the battery cell 110, not sealed, may be disposed to face a cooling plate member 50. Accordingly, as the unsealed portion of the battery cell 110 contacts the cooling plate member 50, the battery cell 110 may be effectively cooled. However, a dispositional direction of the sealing portion 115 is not limited thereto. Meanwhile, a heat transfer member (not shown) such as a heat conductive adhesive may be disposed between the battery cell 110 and the cooling plate member 50 to increase a heat transfer rate.

The protective sheet 30 may be disposed to cover a venting hole 310. For example, one surface of the protective sheet 30 may be in contact with the protective cover 300. However, the present disclosure is not limited thereto, and the protective sheet 30 and the protective cover 300 may be disposed to be spaced apart from each other.

The protective sheet 30 may contact the venting guide member 40, and may be disposed to cover the exhaust portion 42. For example, the other surface of the protective sheet 30 may contact the venting guide member 40 and cover the exhaust portion 42. When the exhaust portion 42 is covered, the internal space 41 of the venting guide member 40 may not be connected to the outside.

FIG. 6 is a cross-sectional view when a portion of the battery cells illustrated in FIG. 5 ignite. FIG. 7 is an enlarged view of portion A of FIG. 6.

The battery cell 110 may ignite by repeatedly performing a process of being charged and discharged. When the battery cell 110 ignites, gas, flames, or the like, may be discharged from the battery cell 110. the gas, flames, or the like may be discharged to the adjacent battery cell 110 or externally of the battery module 10.

According to an embodiment of the present disclosure, when the battery cell 110 ignites gas, flames, or the like is generated, the gas, flames, or the like may be discharged externally of the battery module 10 through the venting hole 310 formed in the protective cover 300. The gas, flames, or the like generated when the battery cell 110 ignites may be in high temperature and high pressure, and the gas, flames, or the like may be discharged through the venting hole 310 and move toward the protective sheet 30.

The gas which is moved toward the protective sheet 30 may press the vulnerable portion 31 and tear or burn a portion of the protective sheet 30. The hole H may be formed in at least a portion of the protective sheet 30, and a position in which the hole H is formed may partially correspond to a position of the ignited battery cell 110. In this case, a portion of the protective sheet 30 corresponding to the position of the unignited battery cell 110 may be closed without forming the hole H.

Gas, flames, or the like may move through the hole H formed in the protective sheet 30 and move into the internal space 41 of the venting guide member 40 that is in contact with the protective sheet 30.

In a process in which gas forms the hole H in the protective sheet 30 and moves into the internal space 41 of the venting guide member 40, pressure and temperature of the gas may be relatively reduced. That is, the gas moving into the internal space 41 may have a lower pressure and temperature than the gas generated when the battery cell 110 ignites.

Gas of which the pressure and temperature have been lowered can move through the inside of the internal space (41). In the process of gas moving through the internal space 41, the gas may move to an exhaust portion 42. For example, the gas may move to the exhaust portion 42 covered with the protective sheet 30 in a closed state. The gas in a state of lowered pressure and temperature may not damage the protective sheet 30 even if it comes into contact with the protective sheet 30. Accordingly, the gas cannot be discharged externally of the venting guide member 40 due to the protective sheet 30 in a closed state and may move back into the internal space 41. Accordingly, the gas that has moved into the internal space 41 may not be discharged externally of the venting guide member 40 through the exhaust portion 42, and may not move to an adjacent battery module 10. Accordingly, according to an embodiment of the present disclosure, thermal runaway of the battery pack may be reduced or prevented.

The gas moving through the internal space 41 may move to both ends of the venting guide member 40. The gas moving to both ends of the venting guide member 40 may be discharged externally through a discharge hole 43 formed in the venting guide member 40. In other words, the internal space 41 may be used as an exhaust passage through which gas can move. In addition, by forming the internal space 41 widely, high-pressure and high-temperature gas can diffuse, and as the gas spreads, the pressure of the gas may be reduced.

According to an embodiment of the present disclosure, the venting guide member 40 may be disposed below the plurality of battery module 10. When the battery cell 110 ignites, foreign substances (combustion materials) in addition to gas or flame may be discharged. Since the foreign substances have a certain density, the foreign substances can easily move into the internal space 41 of the venting guide member 40 disposed therebelow. Like gas, the foreign substances can be discharged externally through the internal space 41 of the venting guide member 40.

In addition, the battery pack 1 according to an embodiment of the present disclosure may be disposed inside a vehicle. Conventionally, when the battery pack is disposed in a vehicle, there were cases in which geothermal heat, foreign substances, and the like, from the outside of the battery pack to a lower portion of the battery pack. Therefore, to prevent this, an air gap has been disposed below the battery pack. In an embodiment of the present disclosure, the venting guide member 40 with the internal space 41 formed as the air gap to maintain a certain distance from a bottom surface is disposed therebelow, and the internal space 41 may be used as an exhaust passage, which may be advantageous in terms of energy density of the battery pack 1.

As set forth above, according to an embodiment of the present disclosure having this configuration, it is possible to reduce or prevent gas generated by a battery module from being transferred to an adjacent battery module.

According to an embodiment of the present disclosure having this configuration, thermal runaway may be reduced or prevented.

Only specific examples of implementations of certain embodiments are described. Variations, improvements and enhancements of the disclosed embodiments and other embodiments may be made based on the disclosure of this patent document. For example, the above-described embodiments may be implemented by deleting some components, and each embodiment may be implemented in combination with each other.

What is claimed is:

1. A battery pack, comprising:
a plurality of battery modules including a cell assembly in which a plurality of battery cells are assembled and a protective cover on which the cell assembly is seated and in which a venting hole is formed;
a pack case protecting the plurality of battery modules from the outside;
a protective sheet disposed to face the venting hole; and
a venting guide member having an internal space, and contacting the protective sheet,
wherein the venting guide member includes an exhaust portion formed on one surface in contact with the protective sheet, and
the gas discharged from the cell assembly moves to the internal space of the venting guide member, passing through the protective sheet and the exhaust portion.

2. The battery pack of claim 1, wherein the protective sheet is disposed to cover the exhaust portion.

3. The battery pack of claim 1, wherein the protective sheet is disposed to cover the venting hole.

4. The battery pack of claim 1, wherein the protective sheet comprises a vulnerable portion formed in a region facing the venting hole, and
a hole is formed in the vulnerable portion when the protective sheet is pressed by gas discharged from the cell assembly.

5. The battery pack of claim 1, wherein the plurality of venting holes are formed in the protective cover, and
at least a portion of the plurality of venting holes are formed on at least a portion of an edge of the protective cover.

6. The battery pack of claim 1, wherein the venting hole has a shape extending in a first direction, and the exhaust portion has a shape extending in the first direction.

7. The battery pack of claim 1, wherein the venting guide member comprises a discharge hole formed in both of the ends of the venting guide member, and
the gas flowing into the internal space of the venting guide member is discharged externally of the venting guide member through the discharge hole.

8. The battery pack of claim 6, wherein the exhaust portion is disposed to correspond the venting hole.

9. The battery pack of claim 1, wherein the pack case comprises a side frame surrounding a side surface of the battery module, and
the venting guide member is coupled to the side frame.

10. The battery pack of claim 1, wherein the protective sheet comprises a plurality of sheets, and
each of the plurality of sheets is disposed to cover each of the plurality of battery modules.

11. The battery pack of claim 1, further comprising:
a cooling plate member disposed to face at least a portion of the plurality of battery modules, and cooling at least a portion of the plurality of battery cells.

12. The battery pack of claim 11, wherein each of the plurality of battery cells comprises a sealing portion, and
at least a portion of the sealing portion are disposed to face the protective sheet.

13. The battery pack of claim 1, wherein the venting guide member is disposed below the plurality of battery modules.

14. The battery pack of claim 1, wherein the pack case comprises a cross frame partitioning a space in which the plurality of battery modules are accommodated.
